(19) United States
(12) Patent Application Publication
(10) Pub. No.: US 2024/0333511 A1
(43) Pub. Date: Oct. 3, 2024

(54) CRYPTOGRAPHIC AUTHENTICATION TO CONTROL ACCESS TO STORAGE DEVICES

(71) Applicant: Capital One Services, LLC, McLean, VA (US)

(72) Inventors: Bryant YEE, Washington, DC (US); Mykhaylo BULGAKOV, Arlington, VA (US); George BERGERON, Falls Church, VA (US)

(73) Assignee: Capital One Services, LLC, McLean, VA (US)

(21) Appl. No.: 18/742,425

(22) Filed: Jun. 13, 2024

Related U.S. Application Data
(63) Continuation of application No. 17/358,473, filed on Jun. 25, 2021, now Pat. No. 12,041,172.

(51) Int. Cl. H04L 9/32; G06F 3/06; G06F 13/42

(52) U.S. Cl. CPC H04L 9/3226; G06F 3/0622; G06F 3/0655; G06F 3/0679; G06F 13/4282; H04L 9/3234; G06F 2213/0042; H04L 2209/805

(57) ABSTRACT

Systems, methods, apparatuses, and computer-readable media for cryptographic authentication to control access to storage devices. An applet executing on a processor of a contactless card may receive, via a wireless communications interface of the contactless card, a request to access a storage device of the contactless card, where the storage device is in a locked state. The applet may generate a cryptogram based on the request and transmit the cryptogram to a computing device via the wireless communications interface. The applet may receive, from the computing device, an indication specifying that a server decrypted the cryptogram. The applet may transmit, to a controller of the storage device and based on the indication specifying that the server decrypted the cryptogram, an indication specifying to unlock the storage device. The controller may transition the storage device from the locked state to an unlocked state based on the indication received from the applet.

### RELATED APPLICATIONS

This application is a continuation of U.S. patent application Ser. No. 17/358,473, filed on Jun. 25, 2021, titled “CRYPTOGRAPHIC AUTHENTICATION TO CONTROL ACCESS TO STORAGE DEVICES”. The contents of the aforementioned application are incorporated herein by reference in their entirety.

### BACKGROUND

Storage devices have become more compact and portable over time. However, these features may cause users to misplace or otherwise lose storage devices. Absent security measures, the data stored on the storage device may be accessible to anyone who possesses a storage device, including any malicious actors. Therefore, unsecured storage devices pose a security risk.

### SUMMARY

Systems, methods, apparatuses, and computer-readable media for cryptographic authentication to control access to storage devices. In one aspect, a method includes receiving, by an applet executing on a processor of a contactless card via a wireless communications interface of the contactless card, a request to access a storage device of the contactless card, where the storage device is in a locked state, generating, by the applet, a cryptogram based on the request, transmitting, by the applet, the cryptogram to a computing device via the wireless communications interface, receiving, by the applet from the computing device, an indication specifying that a server decrypted the cryptogram, transmitting, by the applet to a controller of the storage device and based on the indication specifying that the server decrypted the cryptogram, an indication specifying to unlock the storage device, and transitioning, by the controller based on the indication received from the applet, the storage device from the locked state to an unlocked state.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an aspect of the subject matter in accordance with one embodiment.

FIG. 1B illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 2C illustrates an aspect of the subject matter in accordance with one embodiment.

FIG. 2D illustrates an aspect of the subject matter in accordance with one embodiment.

FIG. 2E illustrates an aspect of the subject matter in accordance with one embodiment.

FIG. 3A illustrates an aspect of the subject matter in accordance with one embodiment.

FIG. 3B illustrates an aspect of the subject matter in accordance with one embodiment.

FIG. 3C illustrates an aspect of the subject matter in accordance with one embodiment.

FIG. 4 illustrates a routine in accordance with one embodiment.

FIG. 5 illustrates a routine in accordance with one embodiment.

FIG. 6A illustrates a contactless card in accordance with one embodiment.

FIG. 6B illustrates a contactless card in accordance with one embodiment.

FIG. 7 illustrates a data structure in accordance with one embodiment.

FIG. 8 illustrates a computer architecture in accordance with one embodiment.

### DETAILED DESCRIPTION

Embodiments disclosed herein provide techniques for cryptographic authentication to control access to storage devices. In one example, a contactless card may include an integrated storage device, such as a universal serial bus (USB) storage device. A controller may generally control access to the storage device, e.g., by locking and/or unlocking the storage device. To unlock the storage device, cryptographic techniques may be used. For example, a user of a computing device may wish to read data on the storage device, write data to the storage device, and/or otherwise access the storage device using one or more applications. In response, the computing device may instruct the user to tap the contactless card to the computing device, thereby bringing the contactless card within wireless communications range with the computing device. The computing device may then wirelessly instruct an applet executing on the contactless card to generate a cryptogram. A wireless card reader of the computing device may read the cryptogram and transmit the cryptogram to an authentication server for verification. If the authentication server does not decrypt of otherwise verify the cryptogram, the server may return a corresponding indication to the computing device. The computing device may then transmit an indication to the contactless card indicating the server did not decrypt or otherwise verify the cryptogram. The controller may then maintain the storage device in a locked state and restrict any attempted access to the storage device, thereby preserving the security of the storage device and any data stored thereon.

If the authentication server is able to decrypt the cryptogram, the authentication server transmit an indication to the computing device indicating the server decrypted the cryptogram. In response, the computing device may transmit, to the applet, an indication specifying that the cryptogram was decrypted or otherwise verified. The applet may then transmit an indication and/or instruction to the controller to unlock the storage device based on the decryption of the cryptogram by the server. The controller may then unlock the storage device and permit the requested access to the storage device. For example, the storage device may be inserted into a USB port of the computing device and the controller may permit access to the storage device (e.g., to read, write, and/or otherwise modify data stored in the storage device). As another example, wireless access to the storage device may be provided, e.g., via wireless data transfer between the contactless card and the computing device. Embodiments are not limited in these contexts.

Advantageously, embodiments disclosed herein provide techniques to secure access to storage devices. By leveraging cryptograms generated by contactless cards, embodiments of the disclosure may securely verify the identity of the user with minimal risk of fraudulent activity. Furthermore, doing so ensures that read/write/modify operations are only permitted on the storage device when the user has access to a contactless card that facilitates the cryptogram verification with the server. Doing so enhances the security of the data stored on the storage device and/or improves the security of the controller.

With general reference to notations and nomenclature used herein, one or more portions of the detailed description which follows may be presented in terms of program procedures executed on a computer or network of computers. These procedural descriptions and representations are used by those skilled in the art to convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

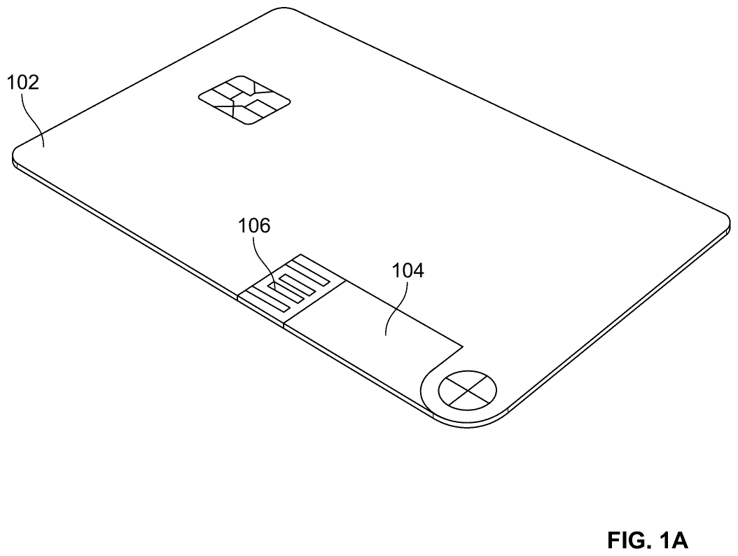

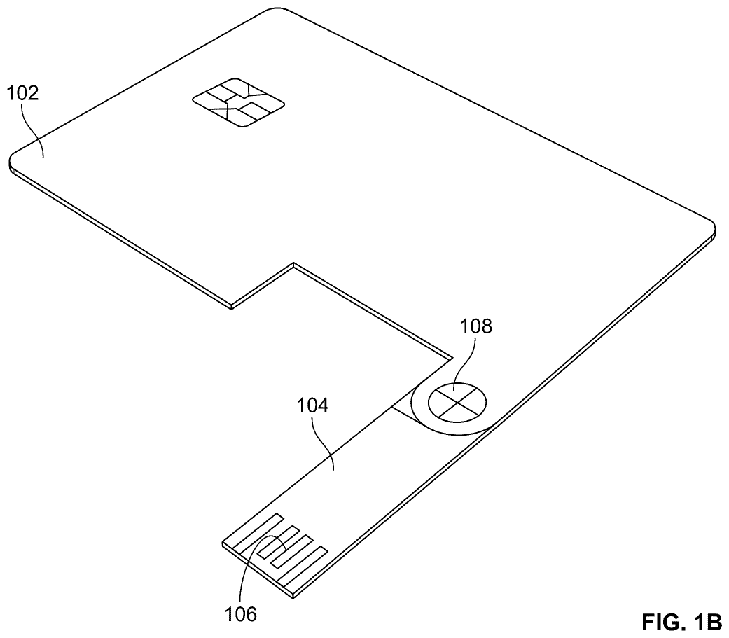

FIG. 1A illustrates an example contactless card 102, according to at least one embodiment. The contactless card 102 is representative of any type of card, such as a credit card, debit card, gift card, smart card, and the like. As shown, the contactless card 102 includes a storage device 104. The storage device 104 includes a non-volatile computer-readable storage medium (not pictured) to store data. Examples of non-volatile storage media include, without limitation, dynamic random access memory (DRAM), static random access memory (SRAM), flash memory, embedded multi-media controllers (eMMC), electrically erasable programmable read-only memory (EEPROM), and the like. The storage device 104 further includes an interface 106 (also referred to as a “connector” herein). Examples of the interface 106 include, but are not limited to, a universal serial bus (USB) interface, which may be used as a reference example herein. For example, the interface 106 may include USB-A connectors, USB-B connectors, USB-C connectors, Lightning connectors, Micro-A connectors, Micro-B connectors, Mini-A connectors, Mini-B connectors, etc.). The interface 106 may be various other forms of interfaces, including external Serial AT Attachment (eSATA), Firewire, etc. In some embodiments, the storage device 104 may communicate via a memory card interface. Accordingly, storage device 104 may be compatible with a memory card family, such as MultiMediaCard (MMC), Secure Digital (SD), Memory Stick, extreme digital (XD), XQD, CompactFlash (CF), etc. The use of USB as a reference example herein is not limiting of the disclosure.

FIG. 1B depicts the contactless card 102 with the storage device 104 in an extended position. As shown, a rotational joint 108 may allow the storage device 104 to extend and/or retract. Although the contactless card 102 depicted in FIGS. 1A-1B are in a particular configuration, embodiments are not limited in this context, as the contactless card 102 may have other suitable configurations for including a storage device 104.

Advantageously, the integrated storage device 104 is of physical dimensions such that the overall dimensions of the contactless card 102 comply with one or more of the various standards for contactless cards, for example, ISO/IEC 7810, ISO/IEC 7811, ISO/IEC 7812, ISO/IEC 7813, ISO/IEC 7816, ISO 8583, ISO/IEC 4909, and ISO/IEC 14443.

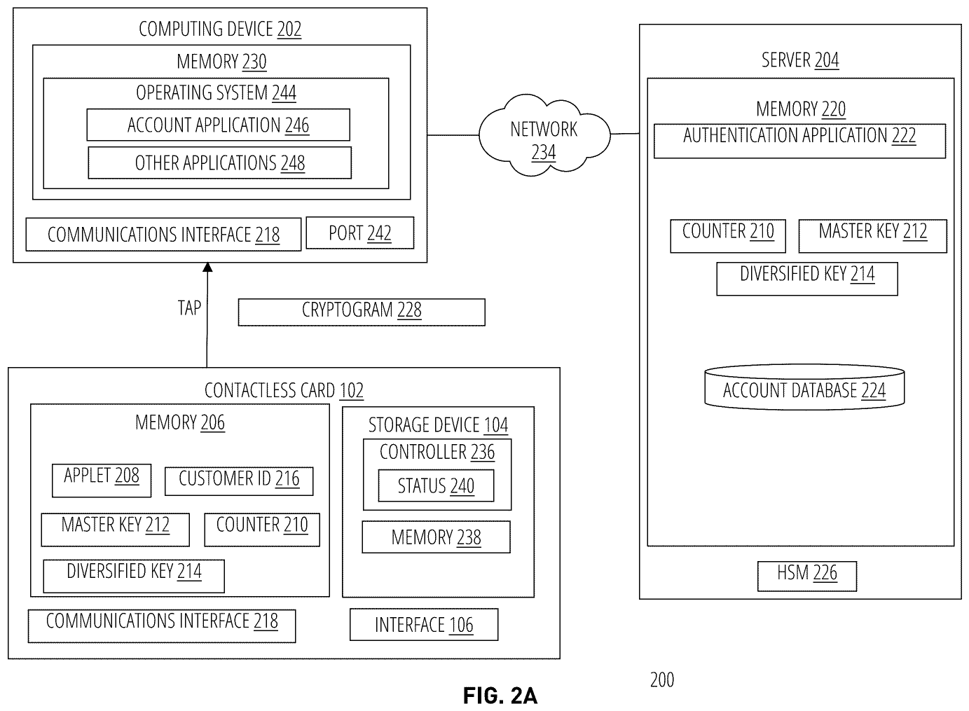

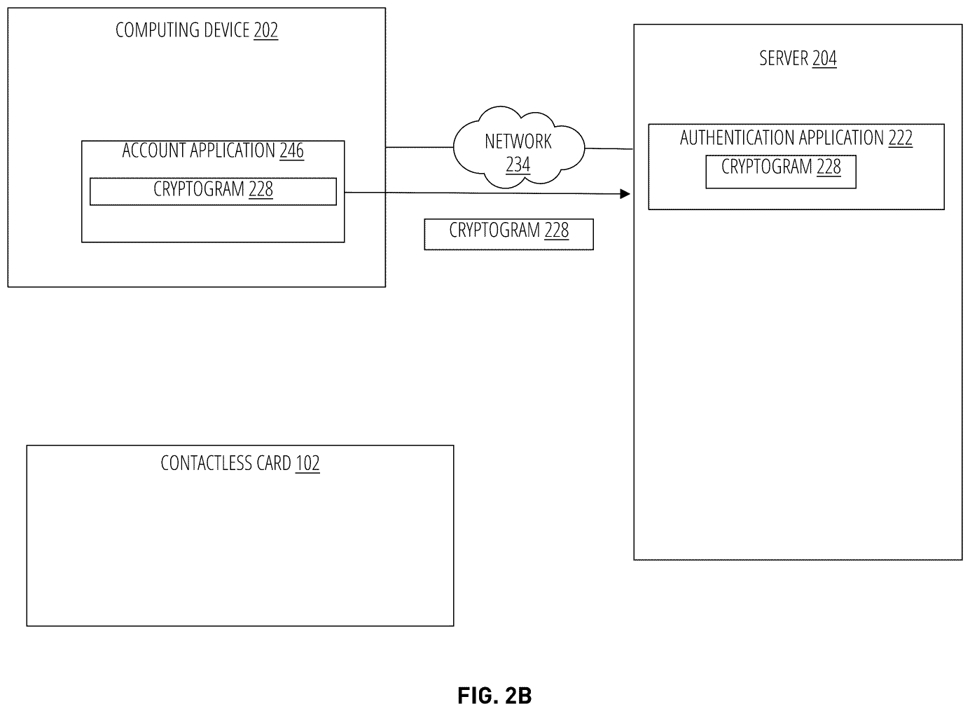

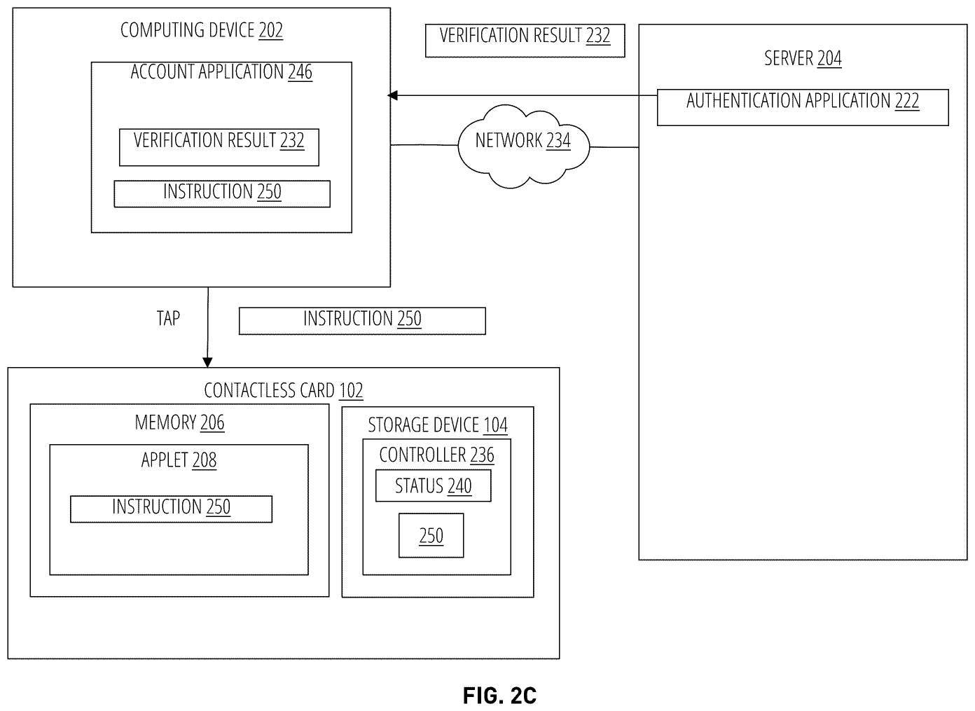

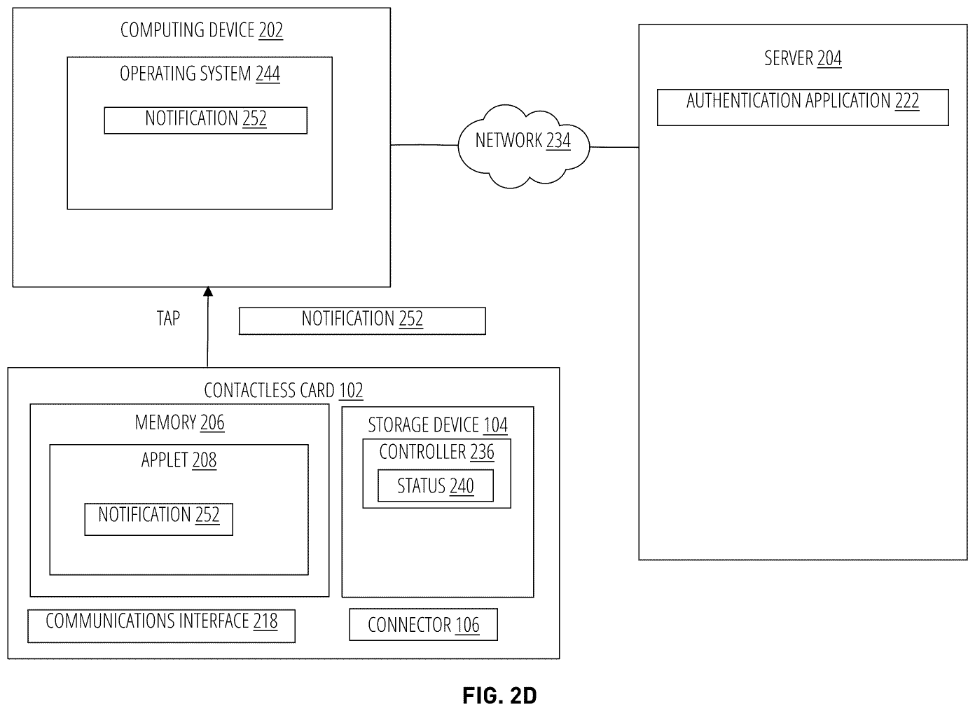

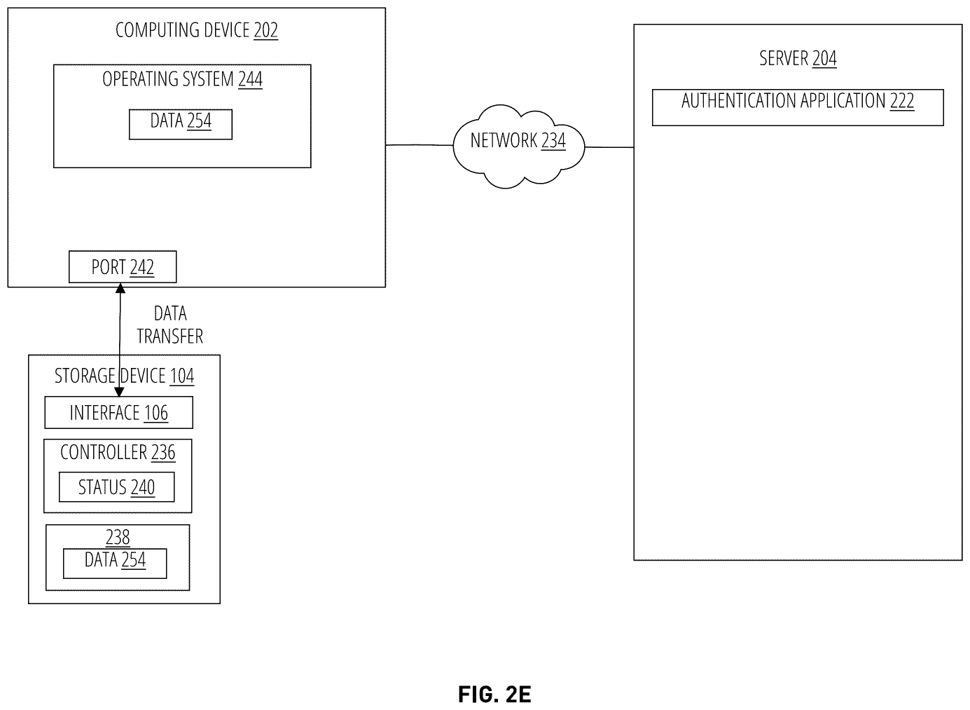

FIG. 2A depicts an exemplary computing architecture 200, also referred to as a system, consistent with disclosed embodiments. Although the computing architecture 200 shown in FIGS. 2A-2E has a limited number of elements in a certain topology, it may be appreciated that the computing architecture 200 may include more or less elements in alternate topologies as desired for a given implementation.

The computing architecture 200 comprises one or more computing devices 202, one or more servers 204, and one or more contactless cards 102. The computing devices 202 and the servers 204 may be communicably coupled via a network 234. As shown, the contactless card 102 may comprise one or more communications interfaces 218, such as a radio frequency identification (RFID) chip, configured to communicate with a communications interface 218 (also referred to herein as a “card reader”, a “wireless card reader”, and/or a “wireless communications interface”) of the computing devices 202 via near field communication (NFC), the EMV standard, or other short-range protocols in wireless communication. Although NFC is used as an example communications protocol herein, the disclosure is equally applicable to other types of wireless communications, such as the EMV standard, Bluetooth®, and/or Wi-Fi.

The computing device 202 is representative of any number and type of computing device, such as smartphones, tablet computers, wearable devices, laptops, portable gaming devices, virtualized computing system, merchant terminals, point-of-sale systems, servers, desktop computers, and the like. A mobile device may be herein used as an example of the computing device 202 but should not be considered limiting of the disclosure. As shown, the computing device 202 includes a wireless communications interface 218 and a port 242. The wireless communications interface 218 is representative of any type of wireless communications interface, such as RFID, Bluetooth, NFC, etc. The port 242 is any interface configured to couple to the interface 106 of the storage device 104. Examples of ports 242 include USB ports, eSATA ports, memory card slots, etc.

The server 204 is representative of any type of computing device, such as a server, workstation, compute cluster, cloud computing platform, virtualized computing system, and the like. Although not depicted for the sake of clarity, the computing device 202, contactless card 102, and server 204 each include one or more processor circuits to execute programs, code, and/or instructions.

As shown, a memory 206 of the contactless card 102 includes an applet 208, a counter 210, a master key 212, a diversified key 214, and a unique customer identifier (ID) 118. The applet 208 is executable code configured to perform the operations described herein. The counter 210, master key 212, diversified key 214, and customer ID 216 are used to provide security in the system 200 as described in greater detail below. The storage device 104 of the contactless card 102 includes a controller 236 and a memory 238. The memory 238 is representative of any type of non-volatile and non-transitory computer-readable storage media. The controller 236 generally controls access to the memory 238 of the storage device 104. As shown, the controller 236 maintains a status 240 reflecting a state of the storage device 104. For example, the state may be a locked state that restricts all operations (e.g., read, write, and/or modify), unlocked state that permits all operations, a read-only state, a read-write state, and the like. In some embodiments, the data stored in the memory 238 of the storage device 104 is encrypted and/or decrypted with the master key 212. The status 240 may be implemented in one or more non-volatile memory units to maintain the status 240 of the storage device 104 if the contactless card 102 does not continuously have sufficient power.

As shown, a memory 230 of the computing device 202 includes an instance of an operating system 244. Example operating systems include the Android® OS, iOS®, macOS®, Linux®, and Windows® operating systems. The operating system 244 includes logic and/or features to communicate with the storage device 104 via one or more ports 242 and the interface 106 of the storage device 104, e.g., according to the USB protocol or any other file transfer protocol. As shown, the operating system 244 includes an account application 246 and one or more other applications 248. The account application 246 allows users to perform various account-related operations, such as activating payment cards, viewing account balances, purchasing items, processing payments, managing files stored in the storage device 104, and the like. In some embodiments, a user may authenticate using authentication credentials to access certain features of the account application 246. For example, the authentication credentials may include a username (or login) and password, biometric credentials (e.g., fingerprints, Face ID, etc.), and the like. The other applications 248 are representative of any type of application that may read data from and/or write data to the memory 238 of the storage device 104. Examples of such applications include file browsers, web browsers, command line interfaces, and the like. As stated, the account application 246 may further include functionality similar to the other applications 248 to read, write, and/or otherwise modify data stored in the memory 238 of the storage device 104. In some embodiments, the other applications 248 include the functionality of the account application 246, e.g., to communicate with the contactless card 102 and/or server 204 for cryptographic authentication as described in greater detail herein.

As shown, a memory 220 of the server 204 includes an authentication application 222, an account database 224, and instances of the master keys 212, diversified keys 214, and counters 210 for each of a plurality of accounts and/or contactless cards 102. The account database 224 generally includes information related to an account holder (e.g., one or more users), one or more accounts of the account holder, and one or more contactless cards 102 of the account.

In some embodiments, a user may desire to perform an operation using the storage device 104. For example, the user may need to access files stored on the storage device 104, modify the files, delete the files, view a listing of files, view directory structures, write new files to the storage device, and the like. Such operations may be performed according to various protocols and/or formats, such as the USB protocol. Advantageously, the system 200 secures the data stored in the storage device 104 by requiring specific cryptographic operations to permit access to the storage device 104. The cryptographic operations may be distinct from cryptographic operations performed by the system 200 to process payments, e.g., via the EMV protocol.

To do so, the user may tap the contactless card 102 to the computing device 202 (or otherwise bring the contactless card 102 within communications range of the communications interface 218 of the device 202). The applet 208 of the contactless card 102 may then generate a cryptogram 228 to unlock the storage device 104, as the status 240 of the storage device 104 may reflect that the storage device 104 is in a locked or otherwise inaccessible state. The cryptogram 228 may be based on the customer ID 216 of the contactless card 102. The cryptogram 228 may be generated based on any suitable cryptographic technique. In some embodiments, the applet 208 may the cryptogram 228 and an unencrypted identifier (e.g., the customer ID 216, an identifier of the contactless card 102, and/or any other unique identifier) as part of a data package. In at least one embodiment, the data package is an NDEF file.

As stated, the computing architecture 200 is configured to implement key diversification to secure data, which may be referred to as a key diversification technique herein. Generally, the server 204 (or another computing device) and the contactless card 102 may be provisioned with the same master key 212 (also referred to as a master symmetric key). More specifically, each contactless card 102 is programmed with a distinct master key 212 that has a corresponding pair in the server 204. For example, when a contactless card 102 is manufactured, a unique master key 212 may be programmed into the memory 206 of the contactless card 102. Similarly, the unique master key 212 may be stored in a record of a customer associated with the contactless card 102 in the account database 224 of the server 204 (and/or stored in a different secure location, such as the hardware security module (HSM) 226). The master key 212 may be kept secret from all parties other than the contactless card 102 and server 204, thereby enhancing security of the system 200. In some embodiments, the applet 208 of the contactless card 102 may encrypt and/or decrypt data (e.g., the customer ID 216) using the master key 212 and the data as input a cryptographic algorithm. For example, encrypting the customer ID 216 with the master key 212 may result in the cryptogram 228. Similarly, the server 204 may encrypt and/or decrypt data associated with the contactless card 102 using the corresponding master key 212.

In other embodiments, the master keys 212 of the contactless card 102 and server 204 may be used in conjunction with the counters 210 to enhance security using key diversification. The counters 210 comprise values that are synchronized between the contactless card 102 and server 204. The counter 210 may comprise a number that changes each time data is exchanged between the contactless card 102 and the server 204 (and/or the contactless card 102 and the computing device 202). When preparing to send data (e.g., to the server 204 and/or the device 202), the applet 208 of the contactless card 102 may increment the counter 210. The applet 208 of the contactless card 102 may then provide the master key 212 and counter 210 as input to a cryptographic algorithm, which produces a diversified key 214 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES107; a symmetric HMAC algorithm, such as HMAC-SHA-250; and a symmetric CMAC algorithm such as AES-CMAC. Examples of key diversification techniques are described in greater detail in U.S. patent application Ser. No. 16/205,119, filed Nov. 29, 2018. The aforementioned patent application is incorporated by reference herein in its entirety.

Continuing with the key diversification example, the applet 208 may then encrypt the data (e.g., the customer ID 216 and/or any other data) using the diversified key 214 and the data as input to the cryptographic algorithm. For example, encrypting the customer ID 216 with the diversified key 214 may result in an encrypted customer ID (e.g., a cryptogram 228). The account application 246 may then read the data package including the cryptogram 228 via the communications interface 218 of the computing device 202. Once read, the account application 246 may transmit the cryptogram 228 to the server 204 for verification.

In some embodiments, the cryptogram 228 is a parameter of a uniform resource locator (URL). For example, the URL may be “http://www.example.com/redirect?param=ABC123&custID=123”. In such an example, the cryptogram 228 may correspond to the parameter “ABC123” and the customer ID 216 may correspond to the parameter “custID”. In such embodiments, the computing device 202 need not have the account application 246 in the foreground when the contactless card 102 is tapped to the computing device 202. Once the URL is received by the operating system 244, the operating system 244 may open an application to process the URL. In some embodiments, the URL may be registered with the account application 246, which causes the operating system 244 to launch the account application 246 and provide the URL with the cryptogram 228 as input to the account application 246. For example, a file explorer page of the account application 246 may be opened responsive to the URL. The account application 246 may then extract the cryptogram 228 from the URL and transmit the cryptogram 228 to the server 204.

FIG. 2B depicts an embodiment where the account application 246 transmits the cryptogram 228 to the server 204. In some embodiments, the account application 246 includes, with the cryptogram 228, an indication specifying that the cryptogram 228 is part of a request to access the storage device 104. Once received, the authentication application 222 may attempt to verify the cryptogram 228. For example, the authentication application 222 may attempt to decrypt the cryptogram 228 using a copy of the master key 212 stored by the server 204. In some embodiments, the authentication application 222 may identify the master key 212 and counter 210 using the unencrypted customer ID 216 (or other identifier) provided by the account application 246 to the server 204. In some examples, the authentication application 222 may provide the master key 212 and counter 210 as input to the cryptographic algorithm, which produces a diversified key 214 as output. The resulting diversified key 214 may correspond to the diversified key 214 of the contactless card 102, which may be used to decrypt the cryptogram 228.

Regardless of the decryption technique used, the authentication application 222 may successfully decrypt the cryptogram 228, thereby verifying or authenticating the cryptogram 228 (e.g., by comparing the customer ID 216 that is produced by decrypting the cryptogram 228 to a known customer ID stored in the account database 224, and/or based on an indication that the decryption using the master key 212 and/or diversified key 214 was successful). Although the keys 114, 116 are depicted as being stored in the memory 220, the keys may be stored elsewhere, such as in a secure element and/or the HSM 226. In such embodiments, the secure element and/or the HSM 226 may decrypt the cryptogram 228 using the master key 212 and/or diversified key 214 and a cryptographic function. Similarly, the secure element and/or HSM 226 may generate the diversified key 214 based on the master key 212 and counter 210 as described above.

If the authentication application 222 is unable to decrypt the cryptogram 228 to yield the expected result (e.g., the customer ID 216 of the account associated with the contactless card 102), the authentication application 222 does not validate the cryptogram 228. In such an example, the authentication application 222 may transmit an indication of the failed decryption to the computing device 202. Upon receipt of the indication of the failed decryption, the account application 246 may reject the requested access to the storage device 104.

FIG. 2C depicts an embodiment where the authentication application 222 successfully decrypts the cryptogram 228 and transmits a verification result 232 to the computing device 202. The verification result 232 generally reflects whether or not the server 204 verified and/or decrypted the cryptogram 228. In the example depicted in FIG. 2C, the verification result 232 may indicate that the server 204 decrypted or otherwise verified the cryptogram 228. Doing so may allow the account application 246 to determine that the cryptogram 228 was successfully verified. In response, the account application 246 may generate an instruction 250 to indicate that the storage device 104 should be transitioned from the locked state to an unlocked state to permit access thereto. If, however, the verification result 232 indicates the server did not verify or otherwise decrypt the cryptogram, the instruction 250 specifies to maintain the storage device 104 in the locked state to restrict the requested access to the storage device 104.

The account application 246 may then output a notification specifying to tap the contactless card 102 to the computing device 202. The account application 246 may then transmit the instruction 250 may to the contactless card 102 via the wireless communications interface. As shown, the applet 208 may receive the instruction 250 and provide the instruction 250 (or some other indication) to the controller 236. Doing so may cause the controller 236 to unlock the storage device 104. In some embodiments, the controller 236 may update the status 240 to reflect that the storage device 104 has been unlocked or is otherwise available for read and/or write access. If, however, the instruction 250 indicates to maintain the storage device 104 in the locked state, the controller 236 maintains the storage device 104 in the locked state and restricts any read/write transactions for the storage device 104. The controller 236 may transmit a confirmation to the applet 208 specifying that the instruction 250 has been implemented and the storage device 104 has been locked and/or unlocked accordingly.

FIG. 2D depicts an embodiment where the applet 208 transmits a notification 252 to the computing device 202 based on successfully unlocking the storage device 104. The notification 252 may generally specify that the storage device 104 was unlocked by the controller 236 and is available for read/write/modify transactions. In some embodiments, the controller 236 unlocks the storage device 104 for a predetermined amount of time, such as 1 minute, 5 minutes, etc. In such embodiments, the notification may specify this predetermined amount of time. Furthermore, the controller 236 may lock the storage device 104 upon expiration of the predetermined amount of time, e.g., when the amount of time since the storage device 104 was unlocked exceeds the predetermined amount of time. In some embodiments, the applet 208 maintains a timer tracking an amount of time since the storage device 104 was unlocked and transmits an instruction to the controller 236 specifying to lock the storage device 104 when the amount of time since the storage device 104 was unlocked exceeds the predetermined amount of time. More generally, controller 236 and/or applet 208 may include logic and/or features to implement a timer, such as logic for a clock.

FIG. 2E depicts an embodiment where the interface 106 of the storage device 104 is inserted into a port 242 of the computing device 202. The operating system 244 and the controller 236 may generally perform one or more operations (e.g., according to the USB protocol) to cause the controller 236 to expose the storage device 104 to the operating system 244. The one or more operations include, but are not limited to, the controller 236 verifying that the status 240 indicates that the storage device 104 is unlocked or otherwise accessible for read and/or write operations. More generally, all operations performed by the computing device 202 and the storage device 104 may be performed and/or formatted according to the USB protocol when the interface 106 is inserted into the port 242.

One or more applications (e.g., the operating system 244, account application 246, and/or other applications 248) may then generate a request to read data 254 from the storage device 104. The request may be formatted according to the USB or other protocols and may be generated responsive to user input. As shown, the data 254 may be transferred from the memory 238 of the storage device 104 to the computing device 202 according to various protocols, such as the USB protocol. Once received, the operating system 244 may provide the data to the requesting application, such as the account application 246 and/or the other applications 248. Although depicted as a read operation, the computing device 202 may also write data to the storage device 104 and/or modify data stored in the storage device 104. Similarly, although the data transfer is described using USB as a reference example, other protocols may be used for data transactions between the computing device 202 and the storage device 104.

Although the data 254 is depicted as being transferred via the interface 106, in some embodiments, the data 254 may be wirelessly communicated. For example, the controller 236 may provide the data 254 to the applet 208. The applet 208 may then wirelessly transmit the data 254 to the computing device 202 (e.g., via NFC, Bluetooth, WiFi, etc.).

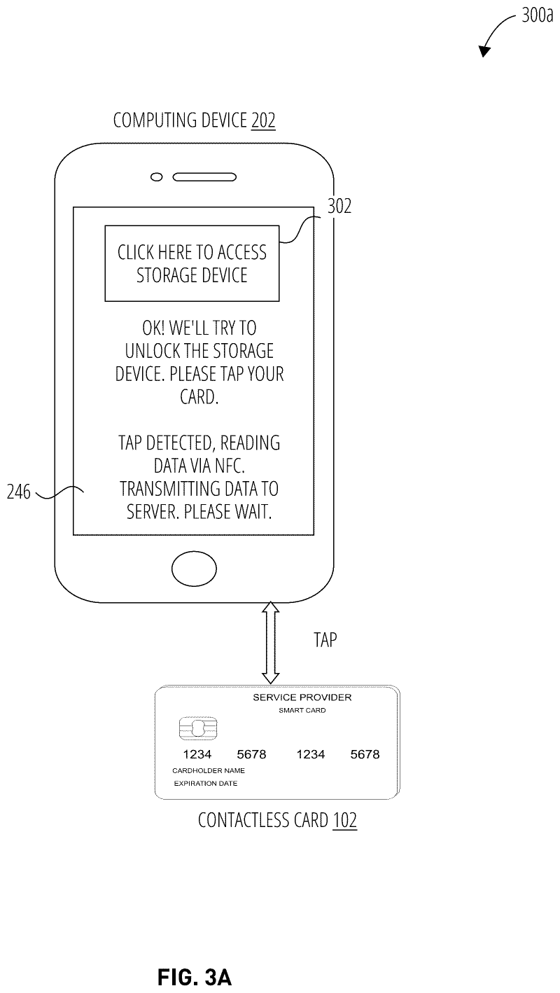

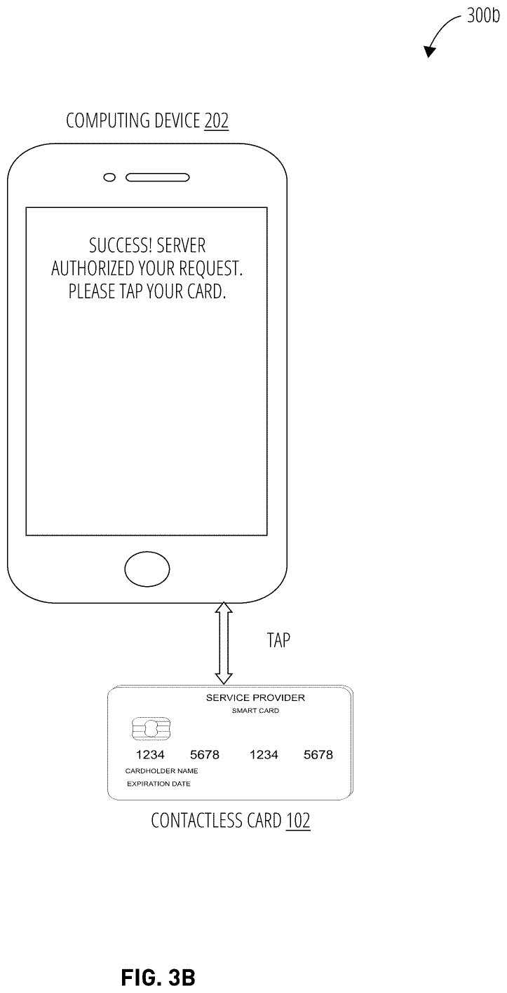

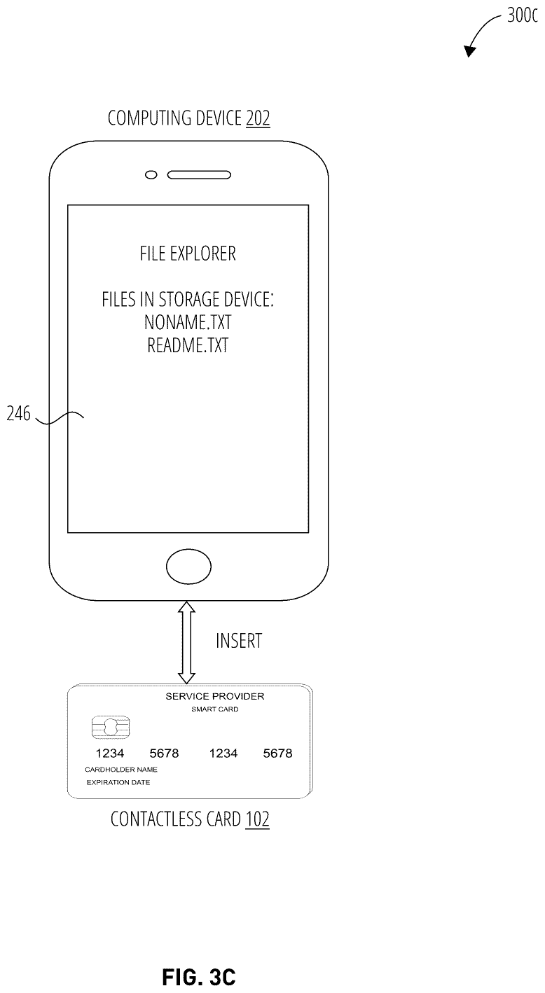

FIG. 3A is a schematic 300a illustrating an example of cryptographic authentication of a storage device integrated in the contactless card 102, according to one embodiment. As shown, the account application 246 may include a selectable element 302 specifying to access the storage device 104. The user may select the element 302, which causes the account application 246 to instruct the user to tap the contactless card 102 to the computing device 202.

As stated, when the contactless card 102 is tapped to the computing device 202, the applet 208 may generate a cryptogram 228. In some embodiments, the cryptogram 228 is a parameter of a URL. The applet 208 may then include the cryptogram 228 and unencrypted identifier (e.g., the customer ID 216) in a data package, such as an NDEF file, that is read by the computing device 202. Responsive to receiving the data package, the account application 246 transmit the data package to the server 204 for verification.

FIG. 3B is a schematic 300b illustrating an embodiment where the account application 246 receives a verification result 232 from the server 204 specifying that the cryptogram was decrypted or otherwise verified as described in greater detail above. The account application 246 may then instruct the user to tap the contactless card 102 to the computing device 202. Doing so causes the account application 246 to transmit an instruction 250 to the contactless card 102. The instruction 250 may generally indicate that the requested access is to be permitted and the controller 236 is to unlock the storage device 104. The controller 236 may then transition the storage device 104 from the locked state to the unlocked state and store an indication of the unlocked state in the status 240. If, however, the verification result 232 indicates the cryptogram 228 is not verified, the instruction 250 indicates to restrict the requested access and the controller 236 maintains the storage device 104 in the locked state.

FIG. 3C is a schematic 300c illustrating an embodiment where the interface 106 of the storage device 104 is inserted into a port 242 of the computing device 202. As shown, the account application 246 displays a file explorer page. The file explorer page may display the contents (or a portion thereof) of the memory 238 of the storage device 104. The file explorer page may generally request to view the contents of the memory 238 via the operating system 244. The controller 236 may receive the request, and determine that the status 240 of the storage device 104 permits the read operation. The controller 236 may then return the results of the read operation to the account application 246, which displays one or more files stored in the storage device 104.

Advantageously, embodiments disclosed herein only permit access to the storage device 104 based on verification of a cryptogram generated by the contactless card 102. If the server 204 is unable to decrypt or otherwise verify the cryptogram, the requested access is denied. Due to the key diversification techniques described herein, the risk of fraudulent or malicious access to the storage device 104 is significantly reduced. Doing so improves the security of the storage device 104 and any data stored therein. Furthermore, doing so improves the controller 236 by providing for advanced cryptographic management of access to the storage device 104.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. In addition, the given logic flow may be implemented by a hardware element, a software element executed by a processor, or any combination thereof. The embodiments are not limited in this context.

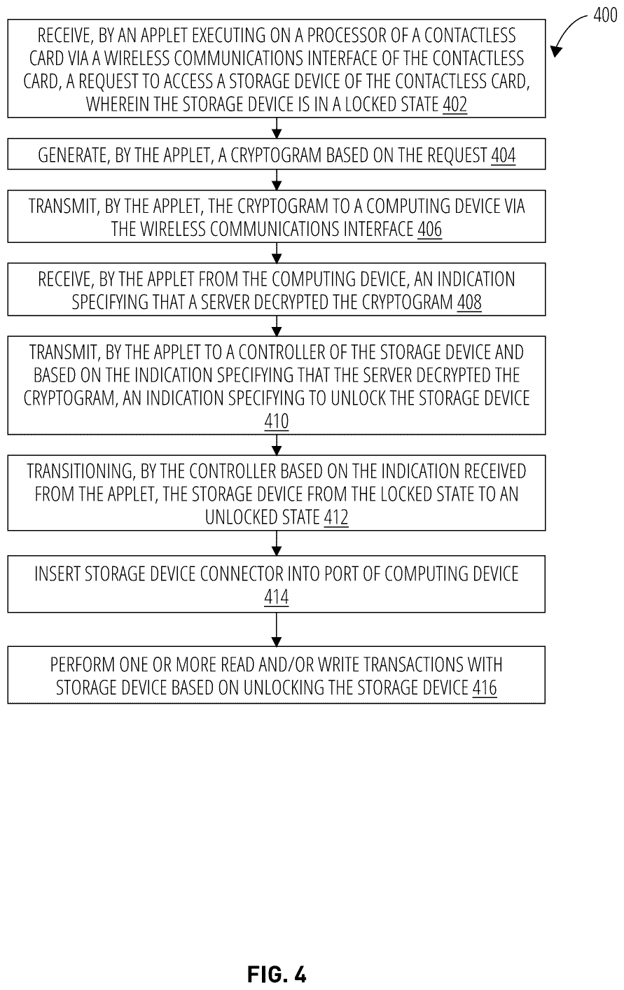

FIG. 4 illustrates an embodiment of a logic flow, or routine, 400. The logic flow 400 may be representative of some or all of the operations executed by one or more embodiments described herein. For example, the logic flow 400 may include some or all of the operations for cryptographically controlling access to the storage device 104 of the contactless card 102. Embodiments are not limited in this context.

In block 402, routine 400 receives, by an applet 208 executing on a processor of a contactless card 102 via a wireless communications interface 218 of the contactless card 102, a request to access a storage device 104 of the contactless card 102, wherein the storage device 104 is in a locked state (e.g., based on the status 240 indicating the storage device 104 is in a locked state). The request may be received from a computing device 202. In block 404, routine 400 generates, by the applet 208, a cryptogram 228 based on the request. In block 406, routine 400 transmits, by the applet 208, the cryptogram 228 to the computing device 202 via the wireless communications interface 218. In block 408, routine 400 receives, by the applet 208 from the computing device 202, an indication specifying that a server 204 verified the cryptogram 228.

In block 410, routine 400 transmits, by the applet 208 to a controller 236 of the storage device 104 and based on the indication specifying that the server 204 verified the cryptogram 228, an indication specifying to unlock the storage device 104. In block 412, routine 400 transitions, by the controller 236 based on the indication received from the applet 208, the storage device 104 from the locked state to an unlocked state. Doing so allows data to be read from and/or written to the memory 238 of the storage device 104. Similarly, other transactions may be permitted, such as deleting files, moving files, etc. For example, when the storage device 104 is inserted into a port 242 at block 414, the controller 236 may expose the storage device 104 to the computing device 202. At block 416, the controller 236 may permit requested operations for the storage device 104 (e.g., read/write/modify operations) based on the status 240 indicating the storage device 104 is accessible.

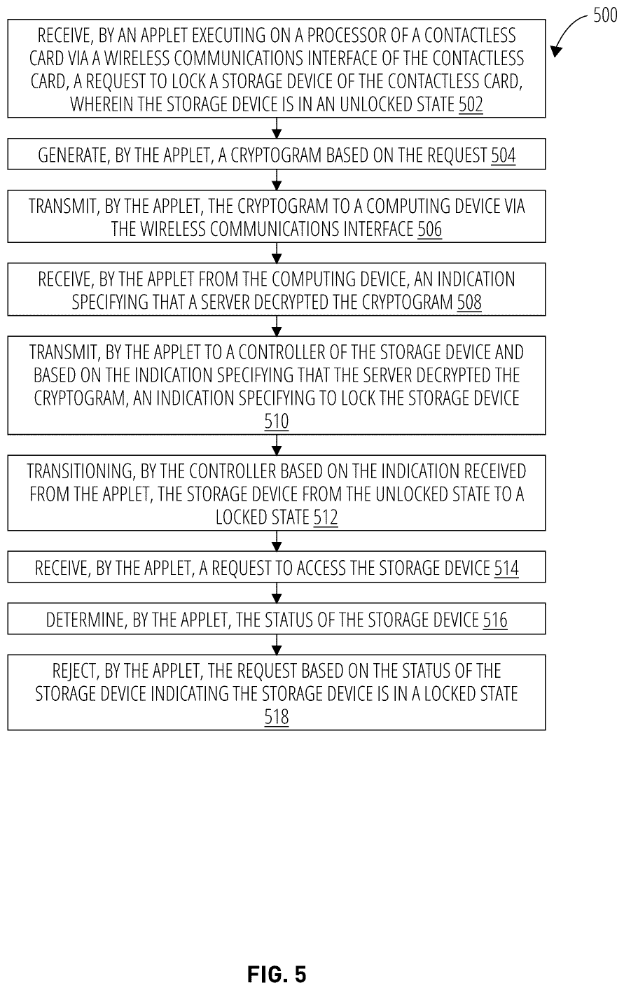

FIG. 5 illustrates an embodiment of a logic flow, or routine, 500. The logic flow 500 may be representative of some or all of the operations executed by one or more embodiments described herein. For example, the logic flow 500 may include some or all of the operations for cryptographically controlling access to the storage device 104 of the contactless card 102. Embodiments are not limited in this context.

In block 502, routine 500 receives, by an applet 208 executing on a processor of a contactless card 102 via a wireless communications interface 218 of the contactless card 102, a request to lock a storage device 104 of the contactless card 102, wherein the storage device 104 is in an unlocked state. The request may be received from a computing device 202. In block 504, routine 500 generates, by the applet 208, a cryptogram 228 based on the request. In block 506, routine 500 transmits, by the applet 208, the cryptogram 228 to the computing device 202 via the wireless communications interface. In block 508, routine 500 receives, by the applet 208 from the computing device 202, an indication specifying that the server 204 decrypted the cryptogram 228.

In block 510, routine 500 transmits, by the applet 208 to a controller 236 of the storage device 104 and based on the indication specifying that the server 204 decrypted the cryptogram 228, an indication specifying to lock the storage device 104. In block 512, routine 500 transitions, by the controller 236 based on the indication received from the applet 208, the storage device 104 from the unlocked state to a locked state. In block 514, routine 500 receives, by the applet 208, a request to access the storage device 104. The access may be a read access, write access, or any other type of access. In block 516, routine 500 determines, by the applet 208, the status 240 of the storage device 104 from the controller 236. In block 518, routine 500 rejects, by the applet 208 and/or the controller 236, the request based on the status 240 indicating the storage device 104 is in a locked state. For example, when the storage device 104 is inserted into a port 242, the controller 236 may restrict the storage device 104 from being exposed to the computing device 202 and reject any requested operations based on the status 240 indicating the storage device 104 is locked or otherwise not accessible.

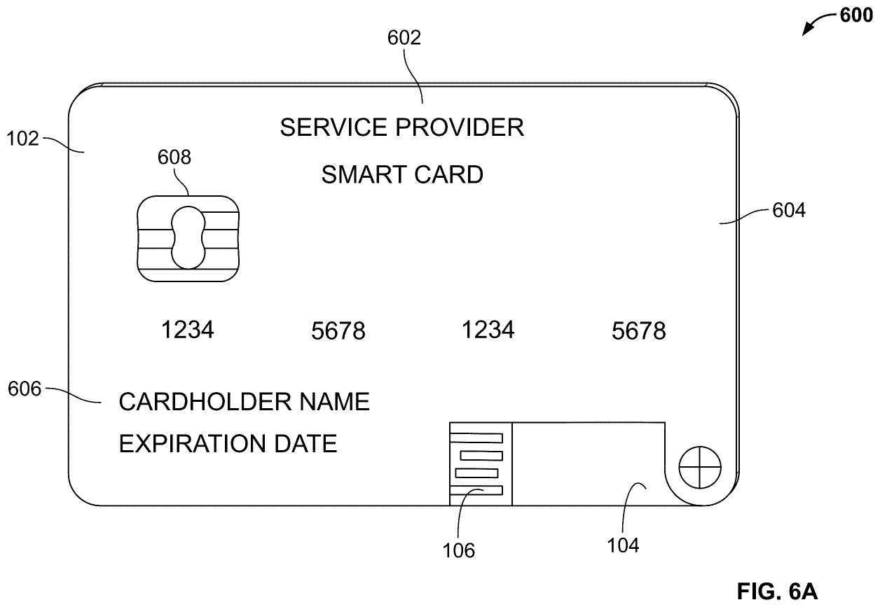

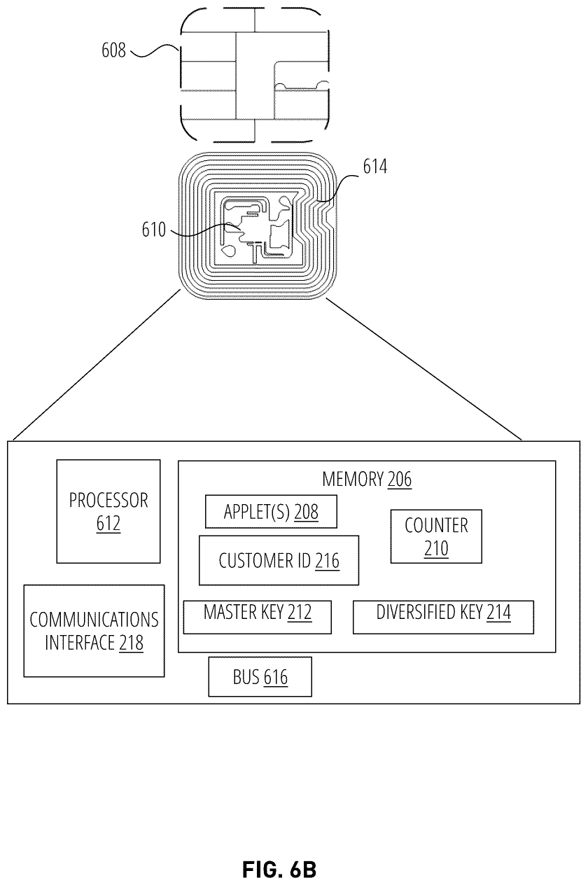

FIG. 6A is a schematic 600 illustrating an example configuration of a contactless card 102, which may include a payment card, such as a credit card, debit card, or gift card, issued by a service provider as displayed as service provider indicia 602 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 604, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 606 displayed on the front and/or back of the card, and a contact pad 608. The contact pad 608 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 6B. These components may be located behind the contact pad 608 or elsewhere on the substrate 604, e.g. within a different layer of the substrate 604, and may electrically and physically coupled with the contact pad 608. The contactless card 102 may also include a magnetic strip or tape, which may be located on the back of the card (not shown in FIG. 6A). The contactless card 102 may also include a Near-Field Communication (NFC) device coupled with an antenna capable of communicating via the NFC protocol. Embodiments are not limited in this manner.

As illustrated in FIG. 6B, the contact pad 608 of contactless card 102 may include processing circuitry 610 for storing, processing, and communicating information, including a processor 612, a memory 206, and one or more communications interface 218. It is understood that the processing circuitry 610 may contain additional components, including processors, memories, error and parity/CRC checkers, data encoders, anticollision algorithms, controllers, command decoders, security primitives and tamper proofing hardware, as necessary to perform the functions described herein.

The memory 206 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 206 may be encrypted memory utilizing an encryption algorithm executed by the processor 612 to encrypt data. In some embodiments, the data stored in the storage device 104 is encrypted using an encryption algorithm executed by the processor 612 and/or the controller 236 to encrypt data. A communications bus 616 may couple the controller 236, the storage device 104, and the processing circuitry 610 of the contact pad 608.

The memory 206 may be configured to store one or more applet 208, one or more counters 210, a customer ID 216, the master key 212, and the diversified key 214. The one or more applet 208 may comprise one or more software applications configured to execute on one or more contactless cards 102, such as a Java® Card applet. However, it is understood that applet 208 are not limited to Java Card applets, and instead may be any software application operable on contactless cards or other devices having limited memory. The one or more counter 210 may comprise a numeric counter sufficient to store an integer. The customer ID 216 may comprise a unique alphanumeric identifier assigned to a user of the contactless card 102, and the identifier may distinguish the user of the contactless card 102 from other users of other contactless cards 102. In some examples, the customer ID 216 may identify both a customer and an account assigned to that customer and may further identify the contactless card 102 associated with the customer's account.

The processor 612 and memory elements of the foregoing exemplary embodiments are described with reference to the contact pad 608, but the present disclosure is not limited thereto. It is understood that these elements may be implemented outside of the contact pad 608 or entirely separate from it, or as further elements in addition to processor 612 and memory 206 elements located within the contact pad 608.

In some examples, the contactless card 102 may comprise one or more antenna(s) 614. The one or more antenna(s) 614 may be placed within the contactless card 102 and around the processing circuitry 610 of the contact pad 608. For example, the one or more antenna(s) 614 may be integral with the processing circuitry 610 and the one or more antenna(s) 614 may be used with an external booster coil. As another example, the one or more antenna(s) 614 may be external to the contact pad 608 and the processing circuitry 610.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the power connection of the contactless card 102, which may be functionally maintained through one or more capacitors. The contactless card 102 may communicate back by switching a load on the coil of the contactless card 102 or load modulation. Load modulation may be detected in the terminal's coil through interference. More generally, using the antenna(s) 614, processor 612, and/or the memory 206, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet 208 may be added to contactless cards to provide a one-time password (OTP) for multifactor authentication (MFA) in various mobile application-based use cases. Applet 208 may be configured to respond to one or more requests, such as near field data exchange requests, from a reader, such as a mobile NFC reader (e.g., of a mobile computing device 202 or point-of-sale terminal), and produce an NDEF message that comprises a cryptographically secure OTP encoded as an NDEF text tag. The NDEF message may include the cryptogram 228, and any other data, such as data stored in the storage device 104.

One example of an NDEF OTP is an NDEF short-record layout (SR=1). In such an example, one or more applet 208 may be configured to encode the OTP as an NDEF type 4 well known type text tag. In some examples, NDEF messages may comprise one or more records. The applet 208 may be configured to add one or more static tag records in addition to the OTP record.

In some examples, the one or more applet 208 may be configured to emulate an RFID tag. The RFID tag may include one or more polymorphic tags. In some examples, each time the tag is read, different cryptographic data is presented that may indicate the authenticity of the contactless card. Based on the one or more applet 208, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter 210 may be configured to increment. In some examples, each time data from the contactless card 102 is read (e.g., by a mobile device), the counter 210 is transmitted to the server for validation and determines whether the counter 210 are equal (as part of the validation) to a counter of the server.

The one or more counter 210 may be configured to prevent a replay attack. For example, if a cryptogram has been obtained and replayed, that cryptogram is immediately rejected if the counter 210 has been read or used or otherwise passed over. If the counter 210 has not been used, it may be replayed. In some examples, the counter that is incremented on the contactless card 102 is different from the counter that is incremented for transactions. The contactless card 102 is unable to determine the application transaction counter 210 since there is no communication between applets 208 on the contactless card 102. In some examples, the contactless card 102 may comprise a first applet 440-1, which may be a transaction applet, and a second applet 440-2. Each applet 440-1 and 440-2 may comprise a respective counter 210.

In some examples, the counter 210 may get out of sync. In some examples, to account for accidental reads that initiate transactions, such as reading at an angle, the counter 210 may increment but the application does not process the counter 210. In some examples, when the mobile device 10 is woken up, NFC may be enabled and the computing device 202 may be configured to read available tags, but no action is taken responsive to the reads.

To keep the counter 210 in sync, an application, such as a background application, may be executed that would be configured to detect when the computing device 202 wakes up and synchronize with the server of a banking system indicating that a read that occurred due to detection to then move the counter 210 forward. In other examples, Hashed One Time Password may be utilized such that a window of mis-synchronization may be accepted. For example, if within a threshold of 10, the counter 210 may be configured to move forward. But if within a different threshold number, for example within 10 or 1000, a request for performing re-synchronization may be processed which requests via one or more applications that the user tap, gesture, or otherwise indicate one or more times via the user's device. If the counter 210 increases in the appropriate sequence, then it possible to know that the user has done so.

The key diversification technique described herein with reference to the counter 210, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

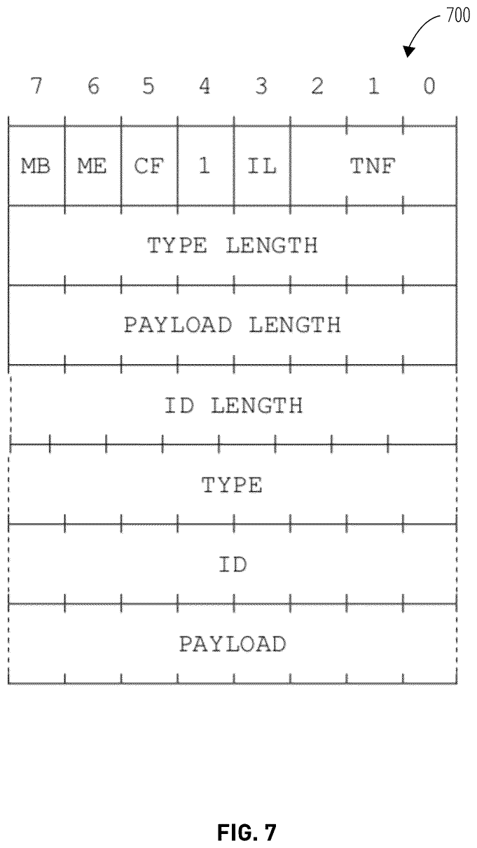

FIG. 7 illustrates an NDEF short-record layout (SR=1) data structure 700 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 700 may include the cryptogram 228, and any other data provided by the applet 208.

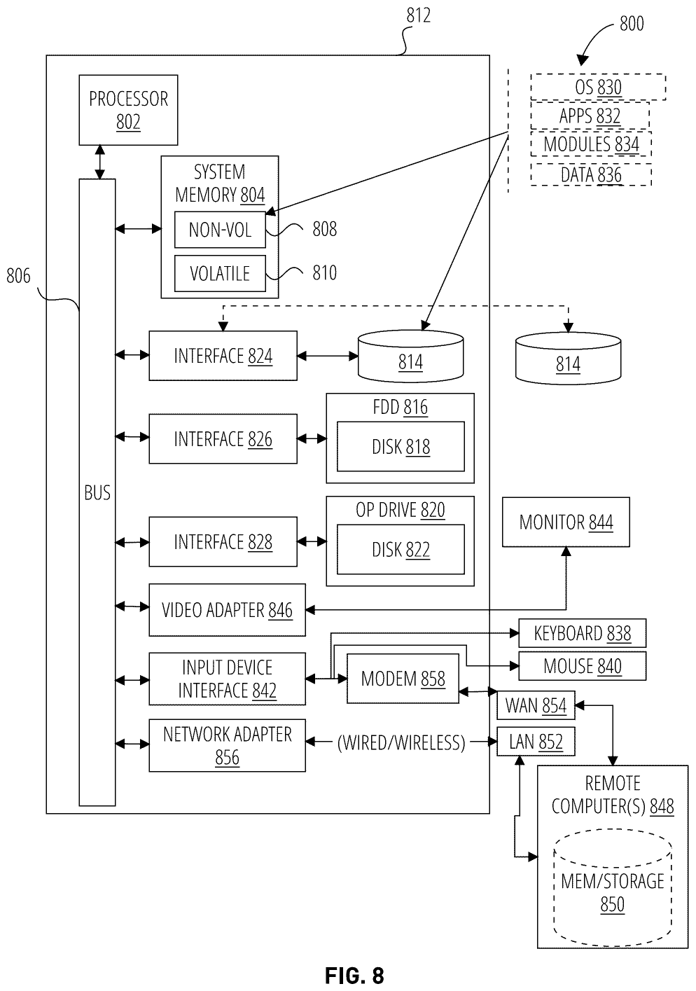

FIG. 8 illustrates an embodiment of an exemplary computer architecture 800 suitable for implementing various embodiments as previously described. In one embodiment, the computer architecture 800 may include or be implemented as part of computing architecture 200.

As used in this application, the terms “system” and “component” are intended to refer to a computer-related entity, either hardware, a combination of hardware and software, software, or software in execution, examples of which are provided by the exemplary computing computer architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 8, the computer architecture 800 includes a computer 812 comprising a processor 802, a system memory 804 and a system bus 806. The processor 802 can be any of various commercially available processors. The computer 812 may be representative of the computing device 202 and/or the server 204.

The system bus 806 provides an interface for system components including, but not limited to, the system memory 804 to the processor 802. The system bus 806 can be any of several types of bus structure that may further interconnect to a memory bus (with or without a memory controller), a peripheral bus, and a local bus using any of a variety of commercially available bus architectures. Interface adapters may connect to the system bus 806 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 804 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 804 can include non-volatile 808 and/or volatile 810. A basic input/output system (BIOS) can be stored in the non-volatile 808.

The computer 812 may include various types of computer-readable storage media in the form of one or more lower speed memory units, including an internal (or external) hard disk drive 814, a magnetic disk drive 816 to read from or write to a removable magnetic disk 818, and an optical disk drive 820 to read from or write to a removable optical disk 822 (e.g., a CD-ROM or DVD). The hard disk drive 814, magnetic disk drive 816 and optical disk drive 820 can be connected to system bus 806 the by an HDD interface 824, and FDD interface 826 and an optical disk drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 808, and volatile 810, including an operating system 830, one or more applications 832, other program modules 834, and program data 836. In one embodiment, the one or more applications 832, other program modules 834, and program data 836 can include, for example, the various applications and/or components of the system 200.

A user can enter commands and information into the computer 812 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 802 through an input device interface 842 that is coupled to the system bus 806 but can be connected by other interfaces such as a parallel port, IEEE 1394 serial port, a game port, a USB port, an IR interface, and so forth.

A monitor 844 or other type of display device is also connected to the system bus 806 via an interface, such as a video adapter 846. The monitor 844 may be internal or external to the computer 812. In addition to the monitor 844, a computer typically includes other peripheral output devices, such as speakers, printers, and so forth.

The computer 812 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all the elements described relative to the computer 812, although, for purposes of brevity, only a memory and/or storage device 850 is illustrated. The logical connections depicted include wire/wireless connectivity to a local area network 852 and/or larger networks, for example, a wide area network 854. Such LAN and WAN networking environments are commonplace in offices and companies, and facilitate enterprise-wide computer networks, such as intranets, all of which may connect to a global communications network, for example, the Internet.

When used in a local area network 852 networking environment, the computer 812 is connected to the local area network 852 through a wire and/or wireless communication network interface or network adapter 856. The network adapter 856 can facilitate wire and/or wireless communications to the local area network 852, which may also include a wireless access point disposed thereon for communicating with the wireless functionality of the network adapter 856.

When used in a wide area network 854 networking environment, the computer 812 can include a modem 858, or is connected to a communications server on the wide area network 854 or has other means for establishing communications over the wide area network 854, such as by way of the Internet. The modem 858, which can be internal or external and a wire and/or wireless device, connects to the system bus 806 via the input device interface 842. In a networked environment, program modules depicted relative to the computer 812, or portions thereof, can be stored in the remote memory and/or storage device 850. It will be appreciated that the network connections shown are exemplary and other means of establishing a communications link between the computers can be used.

The computer 812 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-7 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A contactless card, comprising:
a storage device comprising a controller; and
a processing circuit coupled to the storage device, and to:
receive a request to access the storage device;
generate encrypted data based on the request and provide the encrypted data to a computing device;
receive, from the computing device, an indication that the encrypted data has been decrypted; and
in response to receiving the indication, send a control signal to the controller to alter a locking state of the storage device from a locked state to an unlocked state, thereby granting access to the storage device by the computing device.

2. The contactless card of claim 1, wherein the indication from the computing device includes an instruction to indicate that the locking state of the storage device should be altered.

3. The contactless card of claim 1, wherein the processing circuit is further to receive a second indication that the encrypted data was not verified.

4. The contactless card of claim 3, wherein, in response to receiving the second indication, the processing circuit does not send the control signal and the locking state of the storage device is maintained in the locked state.

5. The contactless card of claim 1 wherein the processing circuit is to execute an applet, wherein the applet is to receive the indication from the computing device and send the control signal to the controller to alter the locking state of the storage device.

6. The contactless card of claim 1, wherein the processing circuit is further to transmit a notification to the computing device in response to the control signal being sent, the notification specifying that the storage device has been unlocked by the controller and is available for read, write, or modify transactions with the computing device.

7. The contactless card of claim 6, wherein, after a predetermined period of time, the processing circuit is further to send a second control signal to the controller to transition the locking state of the storage device from the unlocked state to the locked state again, thereby preventing access to the storage device by the computing device.

8. The contactless card of claim 7, wherein the notification to the computing device includes the predetermined period of time.

9. The contactless card of claim 1, wherein the contactless card includes a wired interface for connecting the storage device to the computing device.

10. The contactless card of claim 9, wherein the wired interface and the storage device are integrated with the contactless card via a rotational joint that allows the storage device and wired interface to extend outward from the contactless card, rotating about the rotational joint.

11. A contactless card comprising:
a storage device comprising:
one or more data files stored thereon;
a wired interface for connecting the storage device to a computing device; and
a controller for controlling a locking state of the storage device;
wherein, in response to the storage device being in an unlocked state and the wired interface being in communication with the computing device, the contactless card is to allow the computing device to access the one or more data files; and
wherein, in response to the storage device being in a locked state and the wired interface being in communication with the computing device, the contactless card is to prevent the computing device to access the one or more data files.

12. The contactless card of claim 11, wherein the storage device and wired interface are integrated with the contactless card via a rotational joint that allows the storage device and wired interface to extend outward from the contactless card, rotating about the rotational joint.

13. The contactless card of claim 11, wherein the storage device comprises a non-volatile computer-readable storage medium.

14. The contactless card of claim 11, wherein the wired interface includes a universal serial bus (USB) interface selected from the group consisting of: a USB-A interface, a USB-B interface, a USB-C interface, a Micro-A interface, a Micro-B interface, a Mini-A interface, and a Mini-B interface.

15. The contactless card of claim 11, wherein the wired interface includes an external Serial AT attachment (eSATA) interface.

16. The contactless card of claim 11, wherein the wired interface being in communication with the computing device includes the wired interface being inserted into a compatible interface of the computing device that includes circuitry capable of allowing the computing device to communicate data, including the one or more data files, with the storage device.

17. The contactless card of claim 11, wherein the contactless card to allow the computing device to access the one or more data files includes the contactless card to allow the computing device to open, view, modify, or delete one of the one or more data files, view a listing of the one or more files, view directory structures, or write new files to the storage device.

18. A method comprising:
receiving, at a processing circuit of a contactless card, a request to access a storage device of the contactless card, the storage device including a controller therefor;
generating, by the processing circuit, encrypted data based on the request and providing the encrypted data to a computing device in communication with the contactless card;
receiving, from the computing device, a message indicating that the encrypted data has been decrypted by an authentication server; and
in response to receiving the message, sending, by the processing circuit, a control signal to the controller to alter a locking state of the storage device from a locked state to an unlocked state, to grant access to the storage device by the computing device.

19. The method of claim 18, further comprising the processing circuit executing an applet, wherein the applet is to receive the message from the computing device and send the control signal to the controller to alter the locking state of the storage device.

20. The method of claim 18, further comprising receiving a second message indicating that the encrypted data was not verified; and
in response to receiving the second indication, the method further comprises maintaining the locking state of the storage device in the locked state.
